(19) United States
(12) Patent Application Publication
(10) Pub. No.: US 2004/0071404 A1
(43) Pub. Date: Apr. 15, 2004

(54) Apparatus for increasing directivity and lowering background light in tap detectors

(76) Inventor: Prafulla Jinendra Masalkar, Breinigsville, PA (US)

Correspondence Address: CHRISTIE, PARKER & HALE, LLP, P.O. BOX 7068, PASADENA, CA, 91109-7068, US

(21) Appl. No.: 10/267,712

(22) Filed: Oct. 9, 2002

(51) Int. Cl. G02B 6/26; G02B 6/34

(52) U.S. Cl. 385/48; 385/37

(57) ABSTRACT

A tap detector monitors an optical signal propagating through a waveguide as a portion of the optical signal is tapped and directed to the monitor detector. A precisely formed grating structure formed within the waveguide surface causes a portion of the propagating optical signal to be coupled out of the waveguide at a particular angle. The grating structure produces an angular separation of light propagating through the waveguide in opposite directions and which is directed out of the waveguide by the grating structure. A monitor detector is positioned to detect the light tapped from the optical signal and to avoid being influenced by any other signals that may be propagating in a direction opposite the optical signal and that are diffracted out of the waveguide by the grating structure.

### FIELD OF THE INVENTION

The present invention is related, most generally, to optoelectronic devices. More particularly, the present invention is directed to an apparatus for monitoring an optical waveguide device such as an optical modulator.

### BACKGROUND OF THE INVENTION

Waveguide based optical devices have many uses in today's optical communication systems. Waveguide based optical modulators, for example, are commonly used in today's optical communication systems to modulate or vary the amplitude of an optical signal passing therethrough. Optical waveguide devices used as optical modulators, or other optical devices, advantageously utilize a detector that monitors the optical output of the device and provides a signal for other control circuitry. A portion of the optical output power of the optical waveguide device is tapped for the monitoring detector which may therefore be referred to as a tap detector. The optical waveguide devices are generally coupled to optical transmission media such as optical fibers. In addition to the optical signal propagating through the waveguide device in the forward propagation direction, another optical signal may originate due to reflections from fiber ends, fiber amplifiers, and other components along the optical signal, and travel backwards through the optical waveguide device. It is a challenge to prevent the backward-traveling optical signal from reaching the monitoring detector. The optical output is provided by the forward propagating optical signal which is the optical signal emitted by the optical source and desired to be monitored. In other words, the detector must have directivity, or directionality, so that it selectively monitors the primary propagated optical output of the waveguide device, and is not influenced by any backward-traveling optical signals.

Optical waveguide devices such as modulators are typically formed on an optical chip and housed within an optical device package. One conventional technique for monitoring the optical waveguide is to position a monitoring detector outside the optical device package. For example, an optical fiber carrying the optical signal may be spliced to provide a branch capable of tapping a detectable portion of the signal, with the detector attached to the end of this fiber branch. Directivity is provided by the splicing of the fiber. If the detector is enclosed within a light absorbing material, it is also possible to lower the background light. This arrangement is cumbersome as it requires additional work such as the splicing of the fiber, the tedious placement of the extra, spliced fiber that might be as much as one meter long, and the attachment of the detector external to the device package.

As an alternative to the optical fiber splicing/external detector apparatus, another approach is to mount the monitoring detector within the housing of the device package. This advantageously provides the advantages of compactness, and ease of assembly. Grating structures formed within the waveguide device, for example, may provide for light to be coupled out of the waveguide and allow for placement of the monitor detector within the device package. An example of a grating structure formed in a waveguide is provided in U.S. Provisional Patent Application Serial No. 60/323,401 to Y. Shi, filed Sep. 19, 2001, the contents of which are hereby incorporated by reference. The shortcoming of locating the detector within the housing, however, is that the background light level within the optical device package is very high due to light scattered at the fiber-waveguide connections and other places in the modulator device. Moreover, the detector lacks directivity as both the forward propagating light and the backward-traveling optical signal are coupled out of the waveguide and sensed by the monitor detector.

Yet another approach is to form a branch of the waveguide itself that taps some of the optical signal from the waveguide output and provides it to the detector. This also allows for the placement of the monitor detector within the package but requires extra space on the device chip making it difficult to design and assemble.

As such, there are demonstrated shortcomings in the conventional approaches used to accurately monitor an optical signal traveling through an optical waveguide device. What is needed in the art, therefore, is an apparatus for monitoring an optical signal traveling through an optical waveguide device. The system should be easy to manufacture and assemble and the monitor should include directivity and not be influenced by backward-propagating optical signals that may be traveling through the waveguide device in a direction opposite to the propagation direction of the primary optical signal desired to be monitored. The monitor should also desirably be uninfluenced by scattered light. The present invention addresses these needs.

### SUMMARY OF THE INVENTION

The present invention provides a waveguide having a surface with a grating structure formed therein. The grating structure directs light out of the waveguide and effectuates an angular separation of light propagating through the waveguide in opposite directions and directed out of the waveguide by the grating structure.

In one embodiment, a detector is positioned facing the waveguide. The detector is positioned to detect light from a forward propagating optical signal that is directed out of the waveguide by the grating structure, and such that light from a backward propagating optical signal and directed out of the waveguide by the grating structure, does not reach the detector.

The present invention further provides an apparatus for monitoring an optical signal propagating through a waveguide. The apparatus includes a waveguide having a surface with a grating structure formed therein. The grating structure effectuates an angular separation of light propagating through the waveguide in opposite directions and directed out of the waveguide by the grating structure such that a first portion of light from a forward propagating optical signal exits the waveguide along a first path and a second portion of light from a backward propagating optical signal exits the waveguide along a second path. The apparatus further includes a detector positioned to detect substantially only the first portion of light that is directed out of the waveguide along the first path.

### BRIEF DESCRIPTION OF THE DRAWING

The following invention is best understood from the following detailed description when read in conjunction with the accompany drawing. It is emphasized that, according to common practice, the various features of the drawing are not to scale. On the contrary, the dimensions of the various features are arbitrarily expanded or reduced for clarity. Like numerals denote like features throughout the specification and drawing. Included in the drawing are the following figures:

FIG. 1 is a schematic view showing an exemplary modulator coupled to optical transmission media;

FIG. 2 is a perspective view showing an exemplary waveguide formed on a substrate and including a grating structure formed therein;

FIG. 3 is a cross-sectional view showing an exemplary grating structure formed within a waveguide;

FIG. 4 is a cross-sectional view showing the grating structure formed within a waveguide and showing a portion of an optical signal diffracted out of the waveguide;

FIG. 5 is a cross-sectional view showing an optical device including a monitor detector mounted over the grating structure of a waveguide;

FIG. 6 is a cross-sectional view showing another exemplary arrangement of a monitor detector positioned over a waveguide;

FIG. 7 is a plan view showing a monitoring detector formed over a waveguide device; and

FIG. 8 is a cross-sectional view showing another exemplary arrangement with optical elements positioned over a waveguide.

### DETAILED DESCRIPTION OF THE INVENTION

The present invention provides an apparatus for monitoring the optical output of an optical waveguide device. Optical waveguide devices including modulators and other optical devices advantageously utilize monitoring detectors that detect a signal tapped off from the optical output. The optical output is produced by a forward-propagating optical signal which is desired to be monitored. This forward-propagating optical signal will generally be emitted by a light source such as a laser and may be a data signal.

The waveguide device may be, for example, a modulator used to code and/or switch on and off a high speed optical signal. The modulator may be used to modulate the amplitude of an optical signal passing therethrough. Such a waveguide device is formed in an optical chip that is coupled at each end to an optical transmission medium such as an optical fiber. The present invention may also be used to monitor the optical output of waveguide devices that form other optical devices. In each case, however, the waveguide device is formed on an optical chip that is generally optically coupled at both ends (or at least at one end) to an optical transmission medium, such as an optical fiber. In addition to the forward-propagating optical signal that provides the optical output of the waveguide, a backward-propagating signal may propagate through the waveguide in an opposite direction. This backward-propagating optical signal may originate due to reflections from fiber ends, fiber amplifiers, and so forth.

The present invention provides an apparatus that selectively monitors the optical output of the waveguide by selectively tapping a portion of the forward-propagating optical signal. The monitor detector is resistant to influence by scattered light and is substantially uninfluenced by any backward-propagating signals which may be present. The monitor detector therefore provides directivity as it senses substantially only the signal propagating in the chosen direction. A grating structure formed within the waveguide, directs light out of the waveguide. The grating structure produces an angular separation of light propagating through the waveguide in opposite directions and which is directed out of the waveguide by the grating structure. For example, a portion of light from a forward propagating optical signal may exit the waveguide along a first path and a portion of light from a backward propagating optical signal may exit the waveguide along a second path. The monitor detector may be positioned outside the periphery of the grating structure and may be positioned to detect substantially only the portion of light that is directed out of the waveguide along the first path. The monitor detector may be coupled to electronic components and may be used to provide a signal for other control circuitry. The signal may be an electrical signal that is representative of the optical output, or forward-propagating optical signal of the waveguide, and may be delivered to various components for various purposes. The control circuitry may then adjust the optical signal, such as by varying the light source.

The present invention finds application in waveguide devices that perform various functions and serve as various optical devices in various optical systems. The following description covers a method and apparatus for monitoring the forward-propagating optical signal travelling through the waveguide, and is not intended to be limited to a modulator or any other particular optical waveguide device.

FIG. 1 is a schematic diagram showing modulator 10 coupled to optical fibers 12 and 14. In other exemplary embodiments, other optical transmission media may be used. Modulator 10 is coupled to optical fibers 12 and 14 using conventional techniques. Light source 16 may be a laser or another light source capable of emitting an optical signal such as a data signal. Modulator 10 is optically coupled to light source 16. The optical signal travels along forward propagation direction 34 and represents the forward-travelling optical signal which may alternatively be referred to as the optical data signal or the forward signal and which produces the optical output of modulator 10. Modulator 10 is formed of a waveguide device, which will be shown and described in detail in subsequent figures. A monitor detector is also included within modulator 10 and is adapted to detect light tapped from the waveguide output and send a signal to control circuitry 18, the signal being representative of the forward signal. The control circuitry 18 may provide feedback which controls or modulates the optical signal such as by adjusting light source 16. It is to be understood that the present invention is directed to monitoring light tapped from a waveguide device and that the optical modulator 10 is exemplary of such a waveguide device and is not intended to be limiting. The following description covers the monitoring of a waveguide device, which may form various other optoelectronic devices.

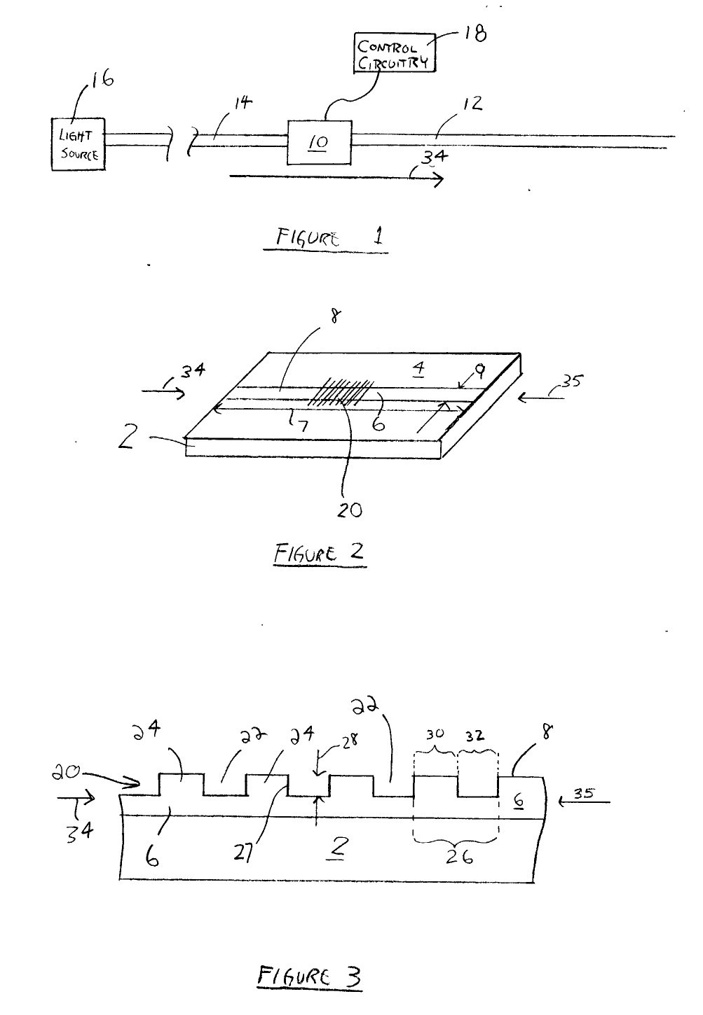

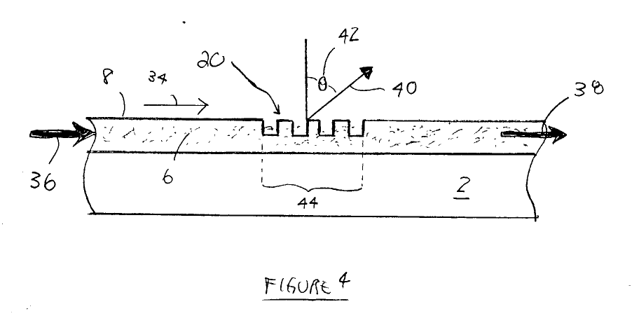

FIG. 2 is a perspective view showing a waveguide device formed in a substrate. Substrate 2 may be formed of indium phosphide, gallium arsenide, glass or other suitable electro-optic materials. In one exemplary embodiment, substrate 2 may be lithium niobate. Substrate 2 may form an optical chip or part thereof. Waveguide 6 is formed within substrate 2 and includes waveguide surface 8. Waveguide 6 may be a strip of impurity species introduced into substrate surface 4 of substrate 2. Conventional ion implantation or other diffusion techniques may be used to form waveguide 6. Waveguide 6 extends longitudinally along forward propagation direction 34 and includes length 7 and width 9. At each of its opposed ends, waveguide 6 may be coupled to an optical transmission medium such as an optical fiber. Length 7 may range from 20 to 200 mm, and may be 50 mm in one exemplary embodiment. Width 9 may range from 5-25 microns and in one exemplary embodiment may be 8 microns. Width 9 may be chosen for compatibility with the diameter of the optical fiber to which the optical waveguide device is coupled. Various impurity species may be introduced into substrate 2 to form waveguide 6. In an exemplary embodiment in which substrate 2 is formed of lithium niobate, titanium may be the impurity species introduced into the substrate to form waveguide 6.

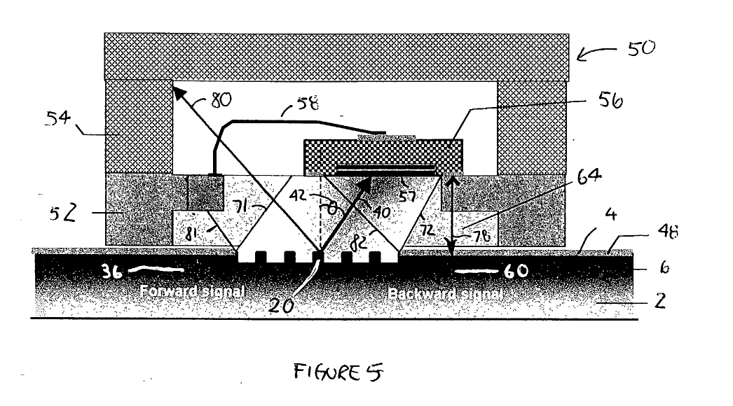

Grating structure 20 is formed within waveguide 6. Grating structure 20 is generally formed of a repeating series of trenches and ridges that are formed to extend essentially orthogonal to forward propagation direction 34, the direction along which the forward-propagating optical signal travels through waveguide 6. In an exemplary embodiment, the series of ridges and trenches repeat periodically. Grating structure 20 is shown in more additional detail in the cross-sectional view shown in FIG. 3. In other exemplary embodiments, the ridges and valleys which form grating structure 20 may not be exactly orthogonal to the longitudinally extending direction of waveguide 6. In the illustrated embodiment, the ridges and trenches that make up grating structure 20 extend laterally past the sides of waveguide 6. In other exemplary embodiments, the ridges and trenches of grating structure 20 may terminate at the sides of waveguide 6. Light traveling through waveguide 6 through forward propagation direction 34 or backward direction 35 will be diffracted out of waveguide 6 by grating structure 20, due to the differences in the respective indexes of refraction of the waveguide material and air. Grating structure 20 is formed within waveguide surface 8 to effectuate an angular separation of light propagating through the waveguide in opposite directions and directed out of waveguide 6 by grating structure 20.

FIG. 3 is a cross-sectional view taken along forward propagation direction 34, or the length of waveguide 6. FIG. 3 shows a section of grating structure 20. Grating structure 20 is formed of a repeating series of ridges 24 and trenches 22. Trenches 22, formed to extend down from waveguide surface 8, may be formed using conventional photolithography and etching methods. In one exemplary embodiment, reactive ion etching may be used. Depth 28 of trenches 22 (or height 28 of ridges 24) may vary from 100 to 600 microns. Up to a depth 28 of about 400 microns, the amount of light tapped out of waveguide 6 varies with depth 28. After a depth 28 of about 400 microns, the increase in the amount of light tapped out is relatively smaller. In the illustrated embodiment, adjacent trenches 22 and ridges 24 are separated by sidewalls 27 which are substantially perpendicular to waveguide surface 8 in the illustrated embodiment. According to other exemplary embodiments, sidewalls 27 may be non-orthogonal with respect to waveguide surface 8. While it is generally advantageous to produce sidewalls 27 in a generally vertical and orthogonal configuration, the light coupled out of waveguide 6 is not generally affected by the configuration of sidewalls 27. Non-orthogonal sidewalls 27 may, however, alter the light propagation conditions with waveguide 6 and may affect the performance of the waveguide device.

Grating structure 20 includes pitch 26 which is the sum of width 30 of ridge 24 and width 32 of an adjacent trench 22. In one exemplary embodiment, width 30 and width 32 may be equal. In another exemplary embodiment, width 30 and width 32 may be different. In one particular exemplary embodiment, width 32 of trench 22 may be chosen to be slightly greater than width 30 of adjacent ridge 24 which combines with trench 22 to form one of the repeating ridge/trench structures that form waveguide 20. Pitch 26 may be constant in the embodiment in which the repeating ridge/trench sequence repeats periodically. Pitch 26 is a factor in establishing the angle at which light is coupled out of waveguide 6. Pitch 26 may vary from 0.5 microns to 2.6 microns in various exemplary embodiments. Pitch 26 will be chosen in conjunction with the wavelength of light propagating through waveguide 6, a portion of which is diffracted out of waveguide 6 by means of grating structure 20. Pitch 26 may be chosen to vary with the magnitude of the wavelength of light traveling through the waveguide.

Grating structure 20 provides directivity (a.k.a. directionality) according to the following principles. Light traveling along each of forward propagation direction 34 and backward direction 35 may be coupled out of waveguide 6 due to grating structure 20. Directivity is achieved by taking advantage of the angular separation of the respective beams that are coupled out of grating structure 20 from forward propagating and backward propagating light, light propagating along forward propagation direction 34 and backward direction 35, respectively. Light couples out of waveguide 6 at an angle of diffraction θ given by:

$$β = K + k sin θ \qquad or \qquad \frac{2 π}{λ} {n}_{eff} = \frac{2 π}{Λ} + \frac{2 π}{λ} ( sin θ )$$

Where β is the propagation constant, n_{eff} is the effective index for the waveguide mode, K is the grating vector magnitude, Λ is the pitch 26 of grating structure 20, k is the wave number, λ is the wavelength of light propagating through waveguide 6, and θ is the angle with the normal to waveguide surface 8.

A waveguide in a lithium niobate substrate, for example, will have effective index of 2.13 for light of 1550 nm wavelength. This light will couple out at an angle of diffraction of 450 from a grating with a pitch of 1 μm. Other pitches 26 can be used and other angles can be achieved for light having other wavelengths, such as 1.3 μm, 0.8 μm, or other wavelengths. Light traveling in opposite directions through the waveguide emerges at the same angle, but on opposite sides of the normal to waveguide 6. Thus, forward propagating and backward propagating light couples out from the grating 20 with an angular separation of 90° for the exemplary embodiment in which light is coupled out at an angle of diffraction of 45°. According to other exemplary embodiments, the angular separation between light propagating through waveguide 6 in opposite directions and directed out of waveguide 6 by grating structure 20, may be as great as 150° and may generally lie within the range of 20° and 120°.

FIG. 4 is a cross-sectional view showing exemplary light ray 40 coupled out of waveguide 6 at angle of diffraction 42. Angle of diffraction 42, the angle between light ray 40 and the normal to waveguide surface 8 in the illustrated embodiment, may range from 10 to 75° in various exemplary embodiments. Light ray 40 is coupled out of waveguide 6 as light propagating through waveguide 6 along forward propagation direction 34 (i.e., forward signal 36) encounters grating structure 20. It may be stated that exemplary light ray 40 is part of the light that is tapped from input forward signal 36. In an exemplary embodiment, grating structure 20 is formed to couple 2-7% of input forward signal 36 out of the waveguide by means of diffraction, that is, 2-7% of the light is tapped. In other exemplary embodiments, 1-10% or more of the light may be tapped. The lower limit of the percentage of light diffracted out of waveguide 6 is determined by factors such as the sensitivity and signal-to-noise ratio of the detector used to sense the tapped light, particularly at lower input power levels. The upper limit of the portion of light coupled out of waveguide 6 by grating structure 20 is determined by the acceptable loss of optical power. The strength of output forward signal 38 is diminished with respect to input forward signal 36 due to the portion of light which is coupled out of waveguide 6.

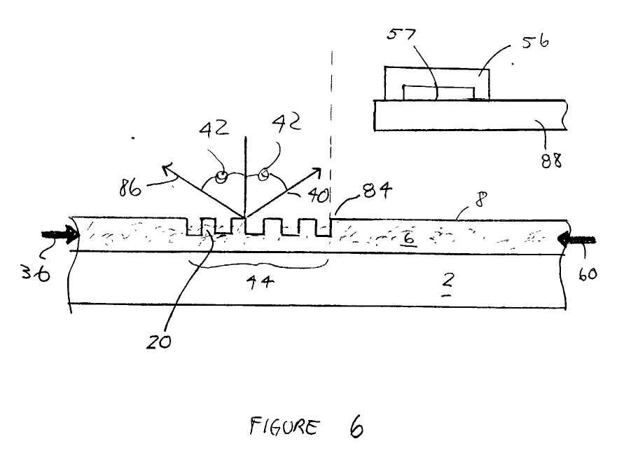

Grating structure 20 includes length 44, which may lie within the range of 100-500 μm but may take on other values in other exemplary embodiments. Length 44 may be chosen in conjunction with the size of the active area of the monitor detector used to sense the light coupled out of waveguide 6. The amount of light diffracted out of waveguide 6 increases with length 44. Light is diffracted out of waveguide 6 along the entire length 44 of grating structure 20. If length 44 exceeds the length of the active area of the detector used to sense the light, a portion of light diffracted out of grating structure 20 will be lost. Light ray 40 represents a single beam of light and is used to illustrate angle of diffraction 42. FIG. 5 shows that light is coupled out of waveguide 6 throughout the length of grating structure 20.

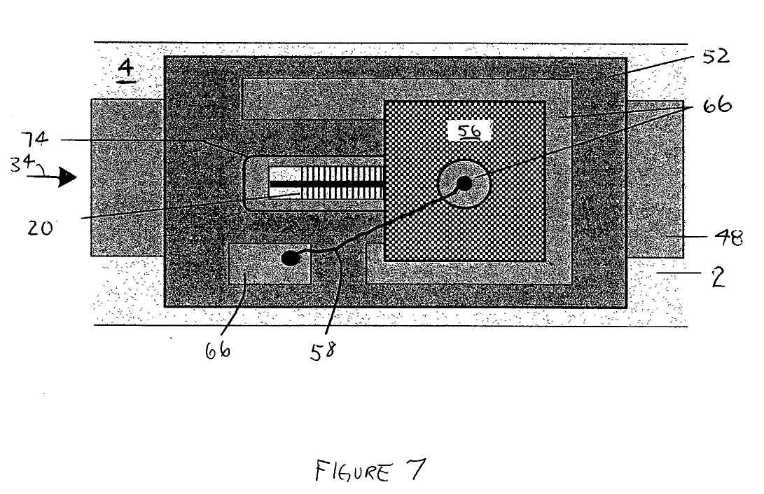

Although not shown, an optical signal traveling right-to-left through waveguide 6 illustrated in FIG. 4 would also have a similar portion of its light coupled out of waveguide 6 due to grating structure 20, at an angle equal to angle 42 and disposed on the opposite, left side of the normal. This will be shown in FIGS. 5 and 6.

FIG. 5 shows monitor detector 56 mounted within cover 50 formed over substrate 2. Monitor detector 56 may be a photodetector that includes an active area for sensing light. Various photodetectors may be used. In one exemplary embodiment, monitor detector 56 may be a P-i-N photodetector. The active area of monitor detector 56 includes active area surface 57 which faces waveguide 6. More particularly, active area surface 57 is generally planar and parallel to waveguide surface 8. Such is intended to be exemplary only, and in other exemplary embodiments, surface 57 may generally face waveguide 6 in configurations other than being parallel to waveguide surface 8. Monitor detector 56 is positioned so that surface 57 faces grating structure 20 and is configured to detect light diffracted out of waveguide 6. In the illustrated embodiment, monitor detector 56 is off-center with respect to grating structure 20.

Cover 50 includes mount 52 and top portion 54. Mount 52 and top portion 56 may each be made of ceramic or other suitable material. In the illustrated embodiment, monitor detector 56 is mounted on a ledge formed by mount 52. In other exemplary embodiments, monitor detector 56 may be fixed in a position facing grating structure 20 at various angles and using various arrangements and in various configurations. FIG. 5 shows monitor detector 56 arranged to detect the portion of light from forward signal 36 that is coupled out of waveguide 6 due to grating structure 20. Light ray 40 is an exemplary ray, but the light coupled out of grating structure 20 is bounded by edges 71 and 72, which bound the beam of light coupled out of waveguide 6. Light ray 40 is coupled out of waveguide 6 at angle 42, described above. Backward signal 60 also includes light coupled out of waveguide 6 at grating structure 20 and represented by exemplary light ray 80 and bounded by edges 81 and 82. The grating structure produces an angular separation of light propagating through the waveguide in opposite directions and which is directed out of the waveguide by the grating structure. It can be seen that active area surface 57 of monitor detector 56 is positioned to have the light tapped from forward signal 36 and bounded by edges 71 and 72, impinge upon its surface, whereas the light tapped from backward signal 60 and bounded by edges 81 and 82 does not reach active area surface 57 of monitor detector 56. In this manner, the arrangement of the present invention utilizes the angular separation of light diffracted from respective signals 36 and 60 to provide directivity by sensing (monitoring) only the forward propagating signal 36 and not being substantially influenced by light from backward signal 60. Cavity 64 serves to trap back reflected and scattered light.

In another exemplary embodiment, a second photodetector (not shown) may be positioned to detect substantially only the portion of light from backward signal 60 that is directed out of waveguide 6 and represented by the light beam bounded by edges 81 and 82, if so desired. The second photodetector can be advantageously positioned to be uninfluenced by light tapped from forward signal 36 and represented by the exiting light beam bounded by edges 71 and 72.

The width of the beam of light coupled out of waveguide 6 and bounded by edges 71 and 72 will vary with the length 44 of grating structure 20, as shown in FIG. 4. The configuration of active area surface 57 of monitor detector 56 may vary, and the area of active area surface 57 may be chosen in conjunction with length 44 of grating structure 20. In one exemplary embodiment, active area surface 57 may be round and include a diameter of 300 μm. Such is exemplary only and various shapes and sizes may be used in other exemplary embodiments.

Surface 57 is spaced above waveguide surface 8 by distance 78. In one exemplary embodiment, distance 78 may be 200 μm, but distance 78 may range from 100 to 1,000 μm in various exemplary embodiments. In an exemplary embodiment in which distance 78 is 200 μm, the directivity, the ratio of light from forward signal 36 sensed by monitor detector 56, to light from backward signal 60 sensed by monitor detector 56, may be 10 dB. Monitor detector 56 develops an electrical signal representative of the amount of light detected. In one exemplary embodiment, the current produced by monitor detector 56 is directly proportional to the intensity of light that is detected. Conductive wire 58 electrically couples monitor detector 56 to other components, such as control circuitry.

Metalization 48 is formed over substrate surface 4 in areas other than grating structure 20 and prevents light scattered within the optical chip from reaching monitor detector 56, thus reducing noise. The optical chip is formed in/on substrate 2 and includes at least waveguide 6 and other components.

FIG. 6 is a cross-sectional view showing another exemplary arrangement of an exemplary monitor detector 56 configured to detect light tapped from forward signal 36 and coupled out of waveguide 6 through grating structure 20. Monitor detector 56 is supported by exemplary mount 88 which may be formed of a material that is transparent to the wavelength of light used. In this exemplary arrangement, monitor detector 56 is offset from grating structure 20 and is positioned outside the periphery of grating structure 20. Grating structure 20 is disposed within a surface region and monitor detector 56 is disposed external to the corresponding space region that projects normal to that surface region occupied by grating structure 20. Stated alternatively, monitor detector 56, including active area surface 57, is not disposed superjacent the surface region occupied by grating structure 20. Rather, surface 57 and monitor detector 56 are disposed beyond edge 84 of grating structure 20 and therefore not over grating structure 20. Edge 84 may be considered the trailing edge of grating structure 20 with respect to forward signal 36 and active area surface 57 is positioned beyond edge 84. Angle of diffraction 42 is chosen so that the light coupled from grating structure 20 and tapped from forward signal 36, such as illustrated by exemplary light ray 40, is directed to active area surface 57 of monitor detector 56. Conversely, light from backward signal 60 which is coupled out of waveguide 6 by means of grating structure 20 and exits waveguide 6 at an angle equal to angle 42 but on the opposite side of the normal, such as representative light ray 86, will not reach surface 57 of monitor detector 56. Monitor detector 56 and active area surface 57 are positioned outside the surface region defined by grating structure 20.

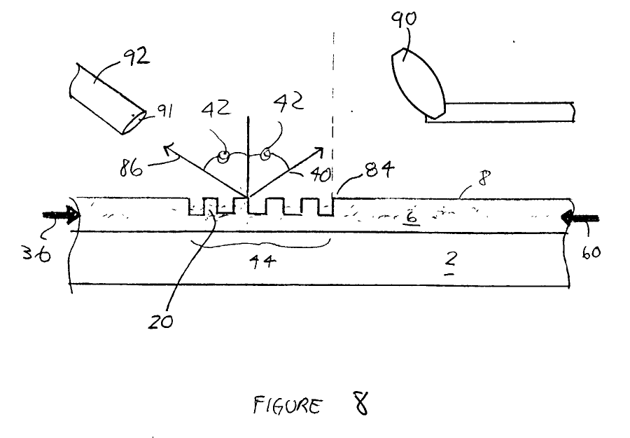

FIG. 7 is a plan view showing aspects of the illustration of FIG. 5, but without top portion 54 of cover 50. Mount 52 is disposed over grating structure 20 of waveguide 6 but includes exemplary slot 70, in which grating structure 20 and some metalization 48 are exposed. The configuration of mount 52 is intended to be exemplary only, and various configurations may be used to position monitor detector 56 over and facing grating structure 20 so as to be positioned to detect light coupled out of the waveguide and from a forward signal, such as a signal traveling along forward propagation direction 34. In the exemplary embodiment in which mount 52 is formed of a material that is transparent to the light coupled out of waveguide 6, slot 70 is not needed. Monitor detector 56 provides an electrical signal, representative of the amount of light detected, by way of conductive wire 58 to metal contacts 66 formed on mount 52. Metal contacts 66 may be coupled to other circuitry, such as control circuitry, which may provide feed-forward or other control techniques to adjust a forward propagating optical signal, such as by adjusting the optical source, which may be a laser, for example.

According to another aspect of the present invention illustrated in the cross-sectional view of FIG. 8, the grating structure 20 that directs light out of waveguide 6 and produces an angular separation of tapped light propagating through the waveguide in opposite directions, may direct the tapped light to another optical element such as a lens, an optical fiber or other optical transmission medium, or any of various other optical receivers capable of receiving optical energy. In this embodiment, grating structure 20 may be used to direct light from forward propagating optical signal 36 to an optical element such as exemplary lens 90 and such that light tapped from backward propagating optical signal 60 does not reach exemplary lens 90. The optical element such as lens 90 may be variously positioned as discussed in conjunction with the detector embodiments and is not limited to the exemplary position illustrated. Lens 90 may also take on various shapes other than the illustrated exemplary embodiment. In the exemplary embodiment illustrated in FIG. 8, two optical receiving elements are shown, each configured to receive light tapped from an optical signal propagating in one direction and uninfluenced by light tapped from an optical signal travelling in the opposite direction. FIG. 8 shows exemplary optical fiber 92 configured to receive light tapped from backward propagating optical signal 60 and uninfluenced by light tapped from forward propagating optical signal 36. Light may be directly coupled into end face 91 of optical fiber 92 or an additional optical element or elements (not shown) may be used to focus and direct the beam of diffracted light, onto optical fiber 92.

The preceding merely illustrates the principles of the invention. It will thus be appreciated that those skilled in the art will be able to devise various arrangements which, although not explicitly described or shown herein, embody the principles of the invention and are included within its scope and spirit. Furthermore, all examples and conditional language recited herein are principally intended expressly to be only for pedagogical purposes and to aid in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and the functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of the present invention is embodied by the appended claims.

What is claimed is:

1. An apparatus for monitoring an optical signal propagating through a waveguide, comprising a waveguide having a surface with a grating structure formed therein, said grating structure effectuating an angular separation of light propagating through said waveguide in opposite directions and directed out of said waveguide by said grating structure.

2. The apparatus as in claim 1, further comprising a detector disposed facing said surface and positioned to detect light from a forward propagating optical signal that is directed out of said waveguide by said grating structure, and such that light from a backward propagating optical signal and directed out of said waveguide by said grating structure, does not reach said detector.

3. The apparatus as in claim 2, in which said grating structure has a leading edge and a trailing edge with respect to said forward propagating optical signal, and said detector is positioned beyond said trailing edge.

4. The apparatus as in claim 3, in which said detector includes a generally planar active area that is substantially parallel to said surface.

5. The apparatus as in claim 2, in which said grating structure defines a surface region and said detector is disposed external a corresponding space region projecting normal to said surface region.

6. The apparatus as in claim 2, in which said waveguide is formed in an optical chip and further comprising a housing coupled to said optical chip, said detector disposed within said housing.

7. The apparatus as in claim 2, in which said detector delivers an electrical signal representative of said forward propagating optical signal.

8. The apparatus as in claim 2, further comprising a light source and at least one optical fiber coupled to said waveguide for providing said forward propagating optical signal to said waveguide.

9. The apparatus as in claim 2, in which said detector detects light from said forward propagating optical signal and directed out of said surface at an angle of between 15° and 75° with the normal to said surface.

10. The apparatus as in claim 1, in which said light propagating through said waveguide is directed out of said surface at an angle of between 15° and 75° with the normal to said surface

11. The apparatus as in claim 1, further comprising an optical receiving element positioned to receive light from a forward propagating optical signal that is directed out of said waveguide by said grating structure, and such that light from a backward propagating optical signal and directed out of said waveguide by said grating structure, does not reach said optical receiving element.

12. The apparatus as in claim 11, wherein said optical receiving element comprises one of an optical fiber and a lens.

13. The apparatus as in claim 1, wherein said waveguide is formed in a lithium niobate substrate.

14. The apparatus as in claim 1, wherein said angular separation lies within a range of 20° to 120°.

15. The apparatus as in claim 1, wherein said waveguide is formed within a substrate and said grating structure includes a plurality of trenches extending downward from said surface.

16. The apparatus as in claim 15, wherein said waveguide is a generally straight strip that extends along a first direction and said grating structure includes a plurality of generally parallel and evenly spaced trenches extending downward from said surface, said trenches extending along a direction substantially orthogonal to said first direction, and adjacent trenches including a pitch of about 0.5 microns to 2.5 microns.

17. The apparatus as in claim 1, in which said waveguide forms part of an optical modulator.

18. The apparatus as in claim 1, in which about 2 to 7 percent of light propagating along said waveguide, is directed out of said waveguide.

19. The apparatus as in claim 1, in which said waveguide is a generally straight strip that extends along a forward propagation direction and said grating structure is a series of alternating raised portions and depressed portions that repeat periodically along said forward propagation direction.

20. The apparatus as in claim 1, in which an optical signal propagates along said waveguide along a light propagation direction and said grating structure directs light out of said surface at an angle expressed by the equation
$$\frac{2 π}{λ} {n}_{eff} = \frac{2 π}{Λ} + \frac{2 π}{λ} ( sin θ )$$
in which n_{eff} is the effective index for the waveguide mode, Λ is the pitch of said grating structure, λ is the wavelength of light of said optical signal, and θ is the angle with the normal to said surface.

21. An apparatus for monitoring an optical signal propagating through a waveguide, comprising:
a waveguide having a surface with a grating structure formed therein, said grating structure effectuating an angular separation of light propagating through said waveguide in opposite directions and directed out of said waveguide by said grating structure such that a first portion of light from a forward propagating optical signal exits said waveguide along a first path and a second portion of light from a backward propagating optical signal exits said waveguide along a second path, and
a detector positioned to detect substantially only said first portion of light that is directed out of said waveguide along said first path.

22. The apparatus as in claim 21, further comprising a further detector positioned to detect substantially only said second portion of light that is directed out of said waveguide along said second path.
